(19) United States
(12) Patent Application Publication
(10) Pub. No.: US 2017/0111269 A1
(43) Pub. Date: Apr. 20, 2017

(54) SECURE, ANONYMOUS NETWORKING

(71) Applicant: ID Vector, Inc., Sterling, VA (US)

(72) Inventors: Benjamin P. Baumgartner, Alexandria, VA (US); Andrew E. Boyce-Lewis, State College, PA (US)

(73) Assignee: ID Vector, Inc., Sterling, VA (US)

(21) Appl. No.: 15/297,739

(22) Filed: Oct. 19, 2016

Related U.S. Application Data
(60) Provisional application No. 62/243,557, filed on Oct. 19, 2015.

(51) Int. Cl. H04L 12/713; H04L 29/06; G06F 9/455; H04L 12/927; H04L 29/08

(52) U.S. Cl. CPC H04L 45/586; H04L 47/803; H04L 67/1031; H04L 67/2823; G06F 9/45558; H04L 63/0281; G06F 2009/4557

(57) ABSTRACT

Some embodiments provide Internet access to a local client device, such as a host computer or mobile device, via a configurable misattribution network. A user of the local client device can quickly and easily declare, via a simple user interface, their desired ephemeral node topology and within a small time window, seamlessly access the Internet via a bounce/egress tunnel. In some embodiments, the misattribution network is ephemeral. A tunnel or point-of-presence (PoP) can last as short or as long as desired by the user. When a PoP is no longer needed, the user can destroy the tunnel. In some such embodiments, deleting the tunnel includes deleting key material, de-spawning compute instances, and releasing IP address(s) back to the provider that owns them so that the IP addresses can be used by other users.

### RELATED APPLICATIONS

This application claims the benefit under 35 U.S.C. §119(e) of U.S. Provisional Patent Application Ser. No. 62/243,557, filed on Oct. 19, 2015 and titled “SECURE, ANONYMOUS NETWORKING,” which is hereby incorporated herein by reference in its entirety.

### FIELD OF THE INVENTION

Some embodiments are directed to a manner of securing and anonymizing data paths through a network. Alternatively or additionally, some embodiments are directed to instantiating server instances in a network and layering secure connections between those instantiated server instances.

### BACKGROUND

Terminals (such as desktops, laptops, tablet, smartphones, and other devices) are identified on a network using identifiers such as MAC addresses and IP addresses. Communications within a network contain those addresses, thereby making it possible to identify an origin of traffic on a network through inspecting the communications and correlating the addresses to the various terminals.

### SUMMARY

Some aspects include a first computing device for securing data communication across at least one network. The first computing device may comprise: at least one processor; and at least one storage medium having encoded thereon executable instructions that, when executed by the at least one processor, cause the at least one processor to carry out a method. The method may comprise: receiving, from a client device, at least one client request regarding a data pathway via the at least one network; in accordance with the data pathway of the at least one client request, instantiating a plurality of resources in the at least one network to support the data pathway, wherein instantiating the plurality of resources comprises instantiating one or more bounce servers and an egress server in the at least one network, wherein the data pathway will traverse the one or more bounce servers and terminate at the egress server; and in response to receiving first information regarding the one or more bounce servers and the egress server: transmitting, to the client device, second information facilitating connection between the client device and a first bounce server of the one or more bounce servers.

Further aspects include at least one computer-readable storage medium encoded with executable instructions that, when executed by at least one processor of a first computing device, cause the at least one processor to carry out a method for securing data communication across at least one network. The method may comprise: receiving, from a client device, at least one client request regarding a data pathway via the at least one network; in accordance with the data pathway of the at least one client request, instantiating a plurality of resources in the at least one network to support the data pathway, wherein instantiating the plurality of resources comprises instantiating one or more bounce servers and an egress server in the at least one network, wherein the data pathway will traverse the one or more bounce servers and terminate at the egress server; in response to receiving, from the at least one second server, first information regarding the one or more bounce servers and the egress server: transmitting, to the client device, second information facilitating connection between the client device and a first bounce server of the one or more bounce servers; and refraining from transmitting, to the client device, information regarding the egress server; instantiating a new egress server; instantiating a second bounce server; transmitting, to the first bounce server and/or the second bouncer server, information facilitating connection between the first bounce server and the second bounce server; and refraining from transmitting, to the first bounce server and the egress server, information facilitating connection between the first bounce server and the egress server.

Additional aspects include at least one computer-readable storage medium encoded with executable instructions that, when executed by at least one processor of a client device, cause the at least one processor to carry out a method for securing data communication across at least one network. The method may comprise: receiving, from a user via a user interface, selection of one or more options for a data pathway, wherein the one or more options comprise an indication of a number of bounce servers to include in the data pathway and one or more distributed computing environments in which the number of bounce servers is to be instantiated; transmitting, to a first server, at least one client request for the data pathway indicating the one or more options; receiving, from the first server, information facilitating connection between the client device and a first bounce server of the number of bounce servers; and forming a connection to the first bounce server without receiving information regarding an egress server.

### BRIEF DESCRIPTION OF THE DRAWINGS

FIG. 1A illustrates a local client device connecting to and authenticating with a management server according to some embodiments.

FIG. 1B illustrates a management server communicating with a cloud provisioning server according to some embodiments.

FIG. 1C illustrates a cloud provisioning server deploying requested instances of bounce and egress servers and applying firewall rules to the instances according to some embodiments.

FIG. 1D illustrates a management server connecting to a bounce server instance, and a management server connecting to an egress server instance via the bounce server instance according to some embodiments.

FIG. 1E illustrates a local client device requesting access to an egress tunnel from a management server and providing a CSR to be signed by the management server according to some embodiments.

FIG. 1F illustrates a management server signing and returning a certificate to a local client according to some embodiments.

FIG. 2 illustrates a process for instantiating an egress tunnel for a misattribution network according to some embodiments.

FIG. 3 illustrates a process of outbound VPN open port identification according to some embodiments.

FIG. 4 illustrates a captive portal detection, man-in-the-middle, and secure negotiation method according to some embodiments.

FIG. 5 illustrates an example of a suitable computing system environment 500 on which embodiments may be implemented.

### DETAILED DESCRIPTION

Some embodiments provide Internet access to a local client device, such as a host computer or mobile device, via a configurable misattribution network. A user of the local client device can quickly and easily declare, via a simple user interface, their desired ephemeral node topology and within a small time window, seamlessly access the Internet via a bounce/egress tunnel.

In some embodiments, the misattribution network is ephemeral. A tunnel or point-of-presence (PoP) can last as short or as long as desired by the user. When a PoP is no longer needed, the user can destroy the tunnel. In some such embodiments, deleting the tunnel includes deleting key material, de-spawning compute instances, and releasing IP address(s) back to the provider that owns them so that the IP addresses can be used by other users.

In some embodiments, the misattribution network is secure. The network traffic, including the true source IP address of the user, is protected via both encryption and compartmentalized design from eavesdroppers, network service providers, and even from the personnel of the provider of the misattribution network. Security can be obtained in a number of ways. For example, in some embodiments, use of both bounce and egress servers ensures that no single system has access to both the true IP address of the user while also having access to unencrypted network traffic. The use of an additional encryption layer between bounce and egress nodes ensures that a user's traffic cannot easily be identified by following encrypted packets as they traverse the Internet. According to some embodiments, the use of both bounce and egress servers may be mandatory.

In some embodiments, the misattribution network requires minimal trust between the different components of the system. Trust relationships between components may be well-defined and minimized. The trust components that may be used in some embodiments include:

a) A local client may trust that a management server is run in a secure fashion, but may not trust intermediary network(s) that connect the local client to the management server. The local client/management server interface may be secured and identified via a Public Key Infrastructure (PKI); specifically Secure Socket Layer (SSL) with Transport Layer Security (TLS) with a private, single-purpose Certificate Authority (CA). A CA may comprise an entity that issues digital certificates certifying that a subject named by a certificate owns a Public Key. It should be appreciated that this document will refer to the collection of systems, protocols and algorithms that are embodied by SSL/TLS collectively as “SSL”.

b) Each Virtual Private Network (VPN) session may be secured with a new private key derived from secret key material created on the egress server and/or the local client. In some embodiments, the secret key material used to create the unique private keys cannot be exported or removed from the egress server and/or local client.

c) The identity of the local client and the egress server may be validated by a CA that is created by a cloud provisioning server. In some embodiments, the CA may be created specifically for each VPN tunnel.

In addition to the foregoing characteristics of the misattribution network, the misattribution network may also be simple to set up by the user. Users may instantiate, use, and then destroy well-designed and secure misattributable network access infrastructure by selecting options such as a number of bounce servers to be instantiated and locations of the bounce and egress servers.

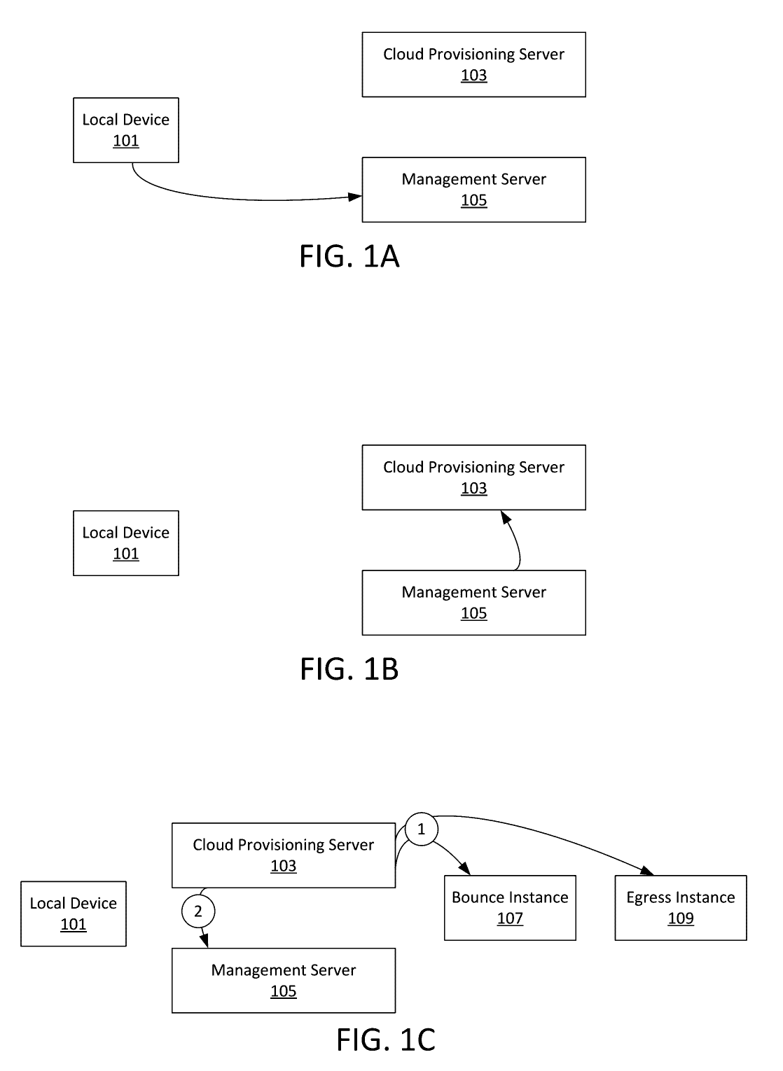

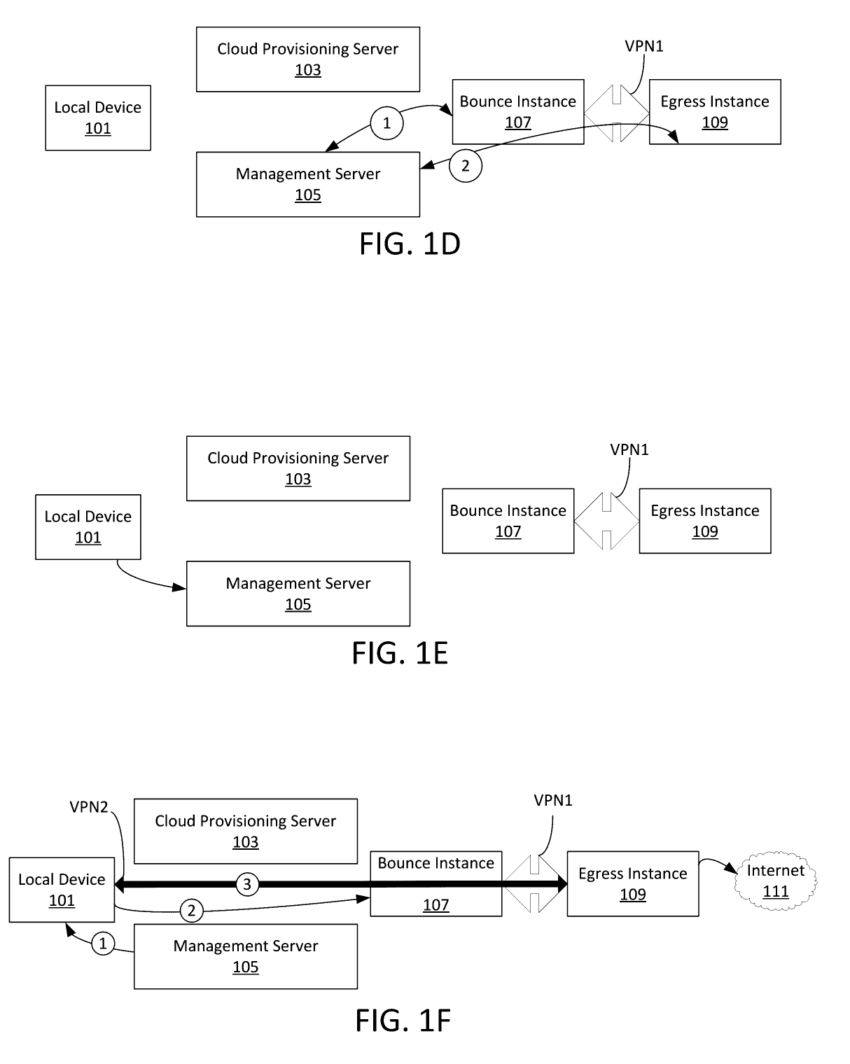

FIGS. 1A-1F illustrate the steps in a process that may be implemented in some embodiments to form a misattribution network. In the example of FIGS. 1A-1F, the misattribution network is formed by a local client device 101, a cloud provisioning server 103 and a management server 105.

Embodiments are not limited to operating with a local client device 101 that is any particular form of computing device. Accordingly, in some embodiments, the local client device 101 may be a laptop or desktop personal computer, a tablet computer, a smart mobile phone, a set-top box, or other device that communicates over the Internet.

In some embodiments, the local client device 101 may be a device that is an accessory to another device, such as an accessory to a user's computing device (e.g., personal computer, smart phone) that connects to the user's computing device. The local client device 101 may connect to the computing device via a wired port of the computing device, such as a Universal Serial Bus (USB) port, Ethernet port, or other port of the device, or may connect via a wireless connection (e.g., Bluetooth, IEEE 802.11, or other wireless connection) or other connection.

Such an accessory or similar device may be used in some embodiments to provide an extra layer of security between a network, such as the Internet, and the computing device. In such embodiments, the local client device 101 may, upon being connected to the computing device, manage network connectivity for the computing device and do so in a secure manner, using techniques described below.

According to some embodiments, the local client device 101 (such as an accessory or dongle that may connect to a computing device, or a computing device such as a laptop or desktop personal computer, mobile phone, or other device) may include a processor and a wired or wireless network interface card. The network interface card may have its own IP address, independent of the user's computing device to which it is connected. In this way, the IP address and/or MAC address of other components of the user's computing device may be obscured to the network. Instead, an IP address and MAC address of the local client device 101 may be used. In addition, the IP address of the local client device 101 may be obscured from the user's computing device. In some embodiments, the MAC addresses of the local client device 101 may be periodically or occasionally changed such that a particular address is never used for any substantial amount of time, thereby preserving the security and anonymity of the connection.

However, because embodiments are not limited to operating with any particular form of local client device 101, it should be appreciated that, in some embodiments, techniques described below as being performed by the local client device 101 may actually be performed by software executing on a client device. For example, techniques described below may be executed by operating system software or application software executing on a mobile phone or tablet computing device, which may be the user's computing device, in possession of the user.

A service provider, which provides network anonymity and security services as described herein, may operate the management server 105. In embodiments in which the local client device 101 is an accessory, as described above, the local client device 101 may be purchased by the end user from the service provider or otherwise provided to the user by the service provider.

The service provider or a third party, such as a cloud service provider, may operate the cloud provisioning server 103. Examples of cloud service providers include Amazon Web Services (AWS) and Rackspace. While only one cloud provisioning server 103 is illustrated in examples below, it should be appreciated that different and/or multiple cloud service providers may instantiate additional servers, such that some tunnels may use server instances with one cloud service provider, other tunnels may use server instances with another cloud service provider, and other tunnels may use server instances with multiple cloud service providers. Accordingly, in some embodiments, there may be multiple different cloud provisioning servers 103.

Embodiments are not limited to operating with any particular form of cloud provisioning server 103, and it should be appreciated that, in some embodiments, techniques described herein as being performed by the cloud provisioning server 103 may actually be performed by software executing on server hardware. For example, techniques described herein may be executed by operating system software, application software, and/or virtual machine(s) executing on one or any number of server devices. Moreover, any number of different or similar cloud networks may be used in any suitable configuration.

In some embodiments, the user, via the local client device 101, may define, create, use, and then destroy a secure misattribution network point-of-presence (PoP). The mechanism and functionality of the system, according to some embodiments, allows the user control over the location and/or lifecycle of a misattribution network PoP, and provides the user with control over with whom (if anyone) the user shares information regarding any particular misattribution network PoP. For example, the user may input a configurable amount of time for which bounce server instances and/or egress server instances may be maintained.

FIG. 1A illustrates the local client device 101 connecting to and authenticating with the management server 105. This may be done, for example, using SOAP web services. According to some embodiments, the local client device 101, pursuant to a user's instruction or automatically, may request that the management server 105 construct a secure misattribution network PoP for the user/device. The management server 105 may instantiate the network PoP as a tunnel through the Internet, which may include one or more relays via bounce servers and an exit from the tunnel via an egress server. To create the tunnel, the management server 105 may instantiate bounce and egress servers, as discussed below.

Embodiments are not limited to operating with any particular form of management server 105, and it should be appreciated that, in some embodiments, techniques described herein as being performed by the management server 105 may actually be performed by software executing on server hardware. For example, techniques described herein may be executed by operating system software, application software, and/or virtual machine(s) executing on one or any number of server devices.

According to some embodiments, a bounce server instance may comprise a virtual machine or process on a machine that may serve as an intermediary between the local client device 101 and an egress server instance, between another bounce server instance and an egress server instance, and/or between other bounce server instances. These virtual machines or processes may be instantiated and/or executed on a distributed set of hardware machines connected to each other via a network. Alternatively or additionally, some bounce server instances may comprise separate hardware machines connected to each other via a network.

According to some embodiments, an egress server instance may comprise a virtual machine or process on a machine or distributed set of hardware machines and may serve as an exit from the network PoP tunnel. Alternatively, an egress server instance may comprise a separate hardware machine.

According to some embodiments, the cloud provisioning server 103 may be configured with software to be executed by the virtual machines once instantiated. Additionally, the cloud provisioning server 103 may instantiate machines and trigger execution of that software.

FIG. 1B illustrates the management server 105 communicating with the cloud provisioning server 103. In some embodiments, the management server 105 may request that instances of one or more bounce servers and an egress server be created for use in the misattribution network. The bounce server(s) and egress server may execute software to perform techniques described below for relaying communications along the tunnel.

FIG. 1C illustrates the cloud provisioning server 103 deploying the requested instances of the bounce and egress servers and applying firewall rules to the instances. In this illustration, the cloud provisioning server 103 creates bounce server instance 107 and egress server instance 109 (marked “1” in FIG. 1C). The cloud provisioning server 103 then transmits the IP addresses of the instance 107 of a bounce server and one instance 109 of a bounce server to the management server 105 (marked “2” in FIG. 1C). While only one bounce server instance is illustrated, it should be appreciated that any number of bounce server instances may be used and that the bounce server instances and egress server instance may be located at any place in the world.

FIG. 1D illustrates the management server 105 connecting to the bounce server instance 107, and management server 105 connecting to the egress server instance 109 via the bounce server instance 107. Once connected, the management server 105 may push configuration parameters to the bounce server instance 107 and/or the egress server instance 109. The configuration parameters may include IP addresses or other information for adjacent server instances. In a case where there is only one bounce server instance 107 and one egress server instance 109, the bounce server instance 107 may be given the IP address of the egress server instance 109 and vice versa. In a case where there are multiple bounce server instances 107, however, the management server 105 may only provide to each instance information on adjacent instances, such that a first bounce server 107 is only aware of the IP address of the next bounce server instance 107 and not aware of the IP address of the egress server 109, and the egress server 109 is only provided with the IP address of the last bounce server instance 107 in the chain. The management server 105 may also receive bounce and egress Certificate Signing Requests (CSR) and may sign and return the signed certificates.

The bounce server instance 107 and egress server instance 109 may then instantiate a bounce-to-egress tunnel, VPN1, based on the bounce and egress certificates signed by the management server 105. VPN1 may be connected as an end-to-end tunnel between the bounce server instance(s) 107 and egress server instance 109. In a case where there are multiple bounce server instances 107, intermediate bounce server instances in the chain may transparently forward VPN connection requests from the first bounce server instance 107 along the chain until they reach egress server 109 and similarly may transparently forward VPN connection responses from the egress server 109 to the first bounce server instance 107. In some embodiments, the bounce and egress server instances 107 and 109 may be configured to only trust certificates signed by the management server 105. The VPN1 tunnel may be created using any suitable VPN technology, including known techniques for instantiating a VPN tunnel.

FIG. 1E illustrates the local client device 101 requesting access to the egress tunnel from the management server 105 and providing a CSR to be signed by the management server 105. In some embodiments, the local client device 101 may be configured only to trust certificates signed by the management server 105.

FIG. 1F first illustrates the management server 105 signing and returning the certificate to the local client device 101 (marked “1” in FIG. 1F). The management server 105 also sends to the local client device 101 the IP address of the first bounce server instance 107. According to some embodiments, the management server 105 will not send to the local client device 101 the IP address of the egress server instance 109. The local client device 101 may have no information regarding the egress server instance 109. The local client device 101 may then initiate a VPN connection to the bounce server instance 107 (marked “2” in FIG. 1F). The bounce server instance 107 may be configured to transparently forward VPN connection packets to the next bounce server instance (if any) or to the egress server instance 109 via VPN1. Accordingly, where there are multiple bounce server instances, the system may relay the VPN connection packets between them over VPN1 until they reach the egress server instance 109. The system may similarly relay responses from the egress server instance 109 back through the bounce server instance(s) 107 over VPN1 to the local client device 101 with the relaying occurring over VPN1 where the relaying is done between the egress server instance 109 and the bounce server instance(s) 107. Once the packets are relayed, a second VPN connection, VPN2, is instantiated (marked “3” in FIG. 1F). VPN2 is a second VPN connection that traverses VPN1 between the first bounce server instance 107 and the egress server instance 109, such that communications between the bounce server instance(s) 107 and the egress server 109 are doubly-encrypted.

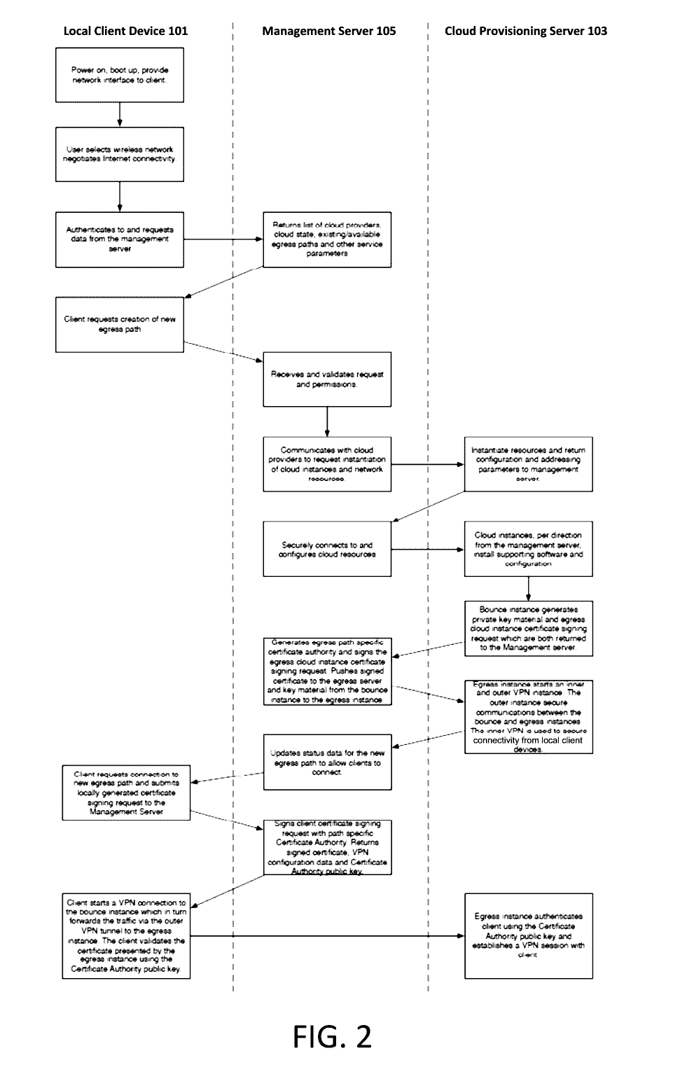

FIG. 2 illustrates a process for instantiating an egress tunnel for the misattribution network in more detail. First, the user turns on and boots the local client device 101, which includes a network interface card for creating a network connection. In some embodiments, the network connection is a wireless network connection. The user selects and connects to the wireless network as is known in the art. The local client device 101 negotiates with a wireless access point for Internet connectivity.

Once Internet connectivity is achieved, the user, via the local client device 101, connects to management server 105. The management server 105 authenticates with the local client device 101 (for example, via a PKI) and the local client device 101 may request configuration data from the management server 105. The management server 105 may send configuration data that defines which PoP providers are available. This configuration data may include, but is not limited to, a list of cloud providers, the state of the cloud instances, existing and/or available egress tunnels, and/or any other service parameters.

Using a graphical user interface, or any other suitable means, the user selects the desired egress tunnel. The user may, for example, specify the desired geographical and/or network locations of the bounce server instances and the egress server instance. The local client device 101 sends a request to the management server 105 for the creation of the new bounce server 107, new egress server 109, and the new egress tunnel. The management server 105 receives and validates the request and permissions. This may include determining whether the user has sufficient funds in their account with the service provider to create and use the desired misattribution network. According to some embodiments, the management server 105 may collect payment from the user using the funds in the user's account with the service provider.

According to some embodiments, the management server 105 then instructs the necessary third party cloud provisioning servers 103 to instantiate bounce and egress server instances as defined by the user. The management server 105 also instantiates a CA for the PoP. In response to the instruction from the management server 105, the third party cloud provisioning servers 103 instantiate the bounce and egress servers and returns configuration and address parameters to the management server 105.

When the misattribution PoP instantiation is complete, the management server 105 connects to and configures the server instances. For example, the management server 105 can direct the server instances to install supporting software and configuration parameters. For example, the bounce server instances and/or the egress server instance may generate private key material and egress cloud instance CSRs and return them to the management server 105.

In response, the management server 105 may request that the cloud provisioning server 103 instantiate an egress tunnel-specific CA and sign the egress cloud instance CSR with this dedicated CA. The signed certificate is returned, via the bounce server instances, to the egress server instance. In response, the egress server instance starts VPN1 and VPN2. The VPN1 instance securely communicates between the bounce server instances and the egress server instance. The VPN2 is used to securely connect the local client device 101 to the egress server instance. Once the VPNs are setup, the management server 105 may update status data for the requested egress tunnel to allow the user to connect. It should be appreciated that using only two VPN instances like VPN1 and VPN2 is an exemplary embodiment. Any number of VPN instances could be used in some embodiments, such as when multiple bounce server instances are used.

The management server 105 signals to the local client device 101 that the new misattribution PoP is now available for use. To connect to the new PoP, the local client device 101 first submits its own CSR to the management server 105 to be signed with the egress-PoP dedicated CA. The management server 105 (after confirming that the local client device 101 is authorized to use this PoP) signs the client's CSR with the dedicated PoP CA. The management server 105 then returns the signed CSR, the CA's public key, and the VPN configuration parameters to local client device 101. The configuration parameters may include, for example, the IP address of the first bounce instance.

The local client device 101 may then connect directly to the egress server and verify the egress server's identity with the CA's public key. Likewise, the egress server can accept connections from the client and verify the validity of the client via the same CA. According to some embodiments, none of the secret key material that is used to secure actual network traffic ever leaves the egress server and/or the local client device 101—it is not stored on or available to the cloud provisioning server 103 or the management server 105. Once authenticated and connected, network traffic from the host that is connected to the local client device 101 is securely and anonymously transmitted to/from the egress PoP.

The tunnel that is created in this manner, and the bounce server instances and egress server instances that are created, may be maintained for any configurable amount of time. In some embodiments, the tunnel and the server instances may be destroyed as soon as the local client device 101 disconnects from the network, which the egress server instance may detect when the VPN2 connection is terminated or when the egress server instance stops receiving communications over the VPN2 connection. In some embodiments, the tunnel may exist until a user inputs a specific command to destroy the tunnel. In still other embodiments, the tunnel may be configured to expire and be destroyed after a configurable amount of time of disuse. The configurable amount of time may be set by user input, by administrator settings, and/or any other suitable way.

Destruction of the misattribution PoP is accomplished by the management server 105 sending a request to the cloud provisioning server 103 to de-instantiate the bounce and egress server instances. All configuration data, any cryptographic material and CA data may be destroyed with the destruction of the misattribution PoP.

When server instances are de-instantiated, information stored by the server instances may be deleted. This may include any information on the location of other server instances in the tunnel, key information, information on data transmitted over the tunnel, or any other information.

According to some embodiments, the local client device 101 may send any number of additional requests to the management server 105 for the creation of additional bounce servers 107, an additional egress server 109, and/or an additional egress tunnel. The local client device 101 may use these servers and tunnel in any combination with currently or previously used servers and tunnel, as described above.

Outbound VPN Open Port/Protocol Identification

Some networks attempt to prevent devices on the network from establishing VPN connections by blocking the ports and protocols conventionally used by VPN software. In some embodiments, the local client device 101 and supporting cloud infrastructure may include features and functionality designed to actively circumvent such network policies. In some embodiments, an Open Port/Protocol Identification system may include:

1) Connectivity Test Daemon(s)—The purpose of the daemon is to provide a target for local client devices 101 to identify which ports/protocols are available. A port may not be available when it has been blocked, filtered, man-in-the-middled, or otherwise shut down or rendered suspicious. The connectivity test daemon may be instantiated as a server daemon that listens on multiple ports for traffic of various protocols. Upon receiving a message, the connectivity test daemon returns (to the client running on local client device 101) an encrypted string that contains the port and protocol on which the message was received. The message that is received may be a connection formation request, in which case local client device 101 may form a connection in response using the port and protocol specified. The connectivity test daemon may execute on a separate, standalone server(s) operated by the service provider than the management server, or may execute on the same server.

2) Management Server—The management server may spawn new connectivity test daemon hosts and inform local client devices 101 of the existence of these hosts. The management server can rotate, or load balance, across multiple connectivity test daemon addresses to prevent local network policies from, upon learning the address of a connectivity test daemon, preventing users from connecting by simply detecting and blocking the address of a particular connectivity test daemon.

3) Bounce/Egress Server—In order to support VPN connectivity across multiple ports and protocols, the bounce server may be specially configured to accept connections on all ports or on ports different from those typically used for VPN connections, and rewrite/redirect incoming traffic along the tunnel to a next bounce server of the path or an egress server.

4) Local Client Device—The local client device 101 may be the component that attempts connectivity to the Connectivity Test Daemon and validates the encrypted response string returned by the Connectivity Test Daemon. Validation of the encrypted response string ensures that there is no proxy or packet content mangling occurring.

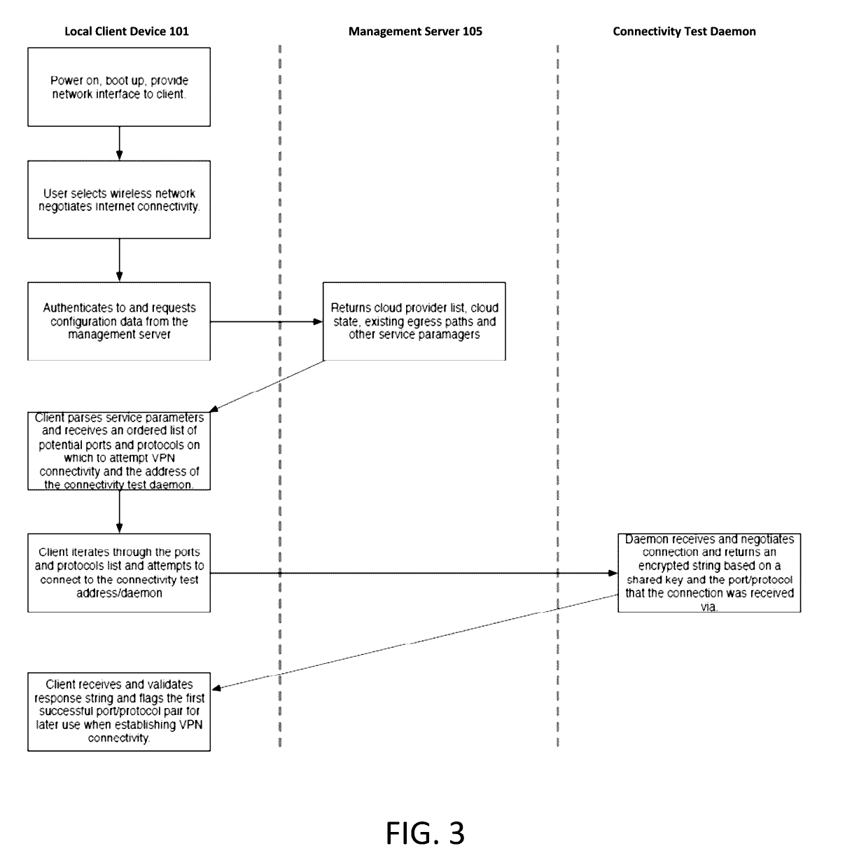

FIG. 3 illustrates the process of outbound VPN open port identification according to some embodiments. According to some embodiments, after booting and connecting to an access point to obtain Internet connectivity, the local client device 101 authenticates to and requests configuration data from the management server 105. The management server 105 returns configuration data and service parameters to the local client device 101. The configuration data and service parameters may include an ordered list of potential ports and protocols on which to attempt a VPN connection, as well as the address of the connectivity test daemon. The local client device 101 then parses the service parameters and receives the aforementioned data.

The local client device 101 then iterates through the ports and protocols list and attempts to connect to the connectivity test daemon address on each port/protocol combination provided by the management server 105. If the information is received by the connectivity test daemon, the daemon negotiates a connection and returns an encrypted string based on a shared key and the port/protocol used to form the connection. The local client device 101 then receives and validates the response string and flags the successful port/protocol combination for later use when establishing a VPN connection.

Captive Portal Detection, Man-in-the-Middle, and Secure Negotiation

One use for techniques described herein is on publicly available WiFi networks such as those commonly found in coffee shops, hotels, and conference centers. These networks provide Internet access in exchange for accepting terms of use and/or payment. When a device connects and attempts to download web content a “captive portal” is often used to distribute terms of use, prompt for payment, or present other content. Because the captive portal system returns unrequested web content, this type of system exposes users to potentially malicious software, data, or configurations. Potential issues include both those intended by the network owner, such as the unrequested display of advertisements or collection of data about the connected device and its network usage, as well as unintended use of the captive portal system by third parties for malicious purposes such as Man in the Middle (MITM) attacks or attempted installation of malicious software on client devices.

Such unrequested web content may include nefarious content, if the captive portal has been compromised or if a man-in-the-middle attack is being used to spoof captive portal content, or in other ways.

Some embodiments include a Captive Portal Detection, Man in the Middle (MITM) and Secure Negotiation system that allows local client device users to securely negotiate connectivity while also protecting users from potentially malicious captive portal content. Some embodiments include:

1) Captive Portal Detection—First, according to some embodiments, the local client device 101 is configured to detect that a captive portal is present. The local client device 101 requests a URL (using local network provided DNS) that is known to produce an Hypertext Transfer Protocol (HTTP) “204” response. A “204” response is the HTTP response code for a successful request that contains zero content. If a captive portal is present, such a request will return a non-zero content length response containing the captive portal web content rather than the expected zero content length response. The presence of content in the response indicates the existence of a captive portal.

2) Content Filtering Proxy—To negotiate connectivity, such as paying for access or agreeing to terms of use, the local client device 101 user interacts with the captive portal and its content. Captive portal content typically includes elements common to web pages, such as text and images. The presence of uncommon content such as executable files or some types of binary data may be used as an indication that the captive portal is being used as part of an attack.

To aid with securely negotiating connectivity, the local client device 101 carries out a proxy process to examine captive portal content before the content is relayed to a web browser on the users computing device. If the proxy detects uncommon content or content that has been identified as potentially nefarious, the proxy blocks the content from being delivered to the user's computing device and instead sends a notification and error message. The proxy acts as a content filter during captive portal negotiations so that nefarious objects may be removed while safe content may still be relayed. This system aids in preventing captive portal attacks that present malicious binaries, executables or other web content to the user and/or user's machine while captive portal negotiation is taking place.

3) SSL Downgrade—The Content Filtering Proxy is a useful solution to captive portals that work over HTTP. However, the techniques may be difficult to use with a captive portal that uses an HTTPS connection. When the HTTPS connection extends through the proxy rather than terminating at the proxy, the content is encrypted as it is relayed through the proxy and cannot be inspected or filtered. Therefore, this HTTPS-delivered content represents a potential threat to users. HTTPS captive portals may also be problematic because many users may trust HTTPS connections despite there being no guarantee that the delivered content is not unrequested or malicious.

The local client device 101 may therefore include an SSL downgrade mechanism that provides for content filtering and inspection of HTTPS traffic. The SSL downgrade mechanism inspects unencrypted response data for URLs that, if accessed, would result in an HTTPS (encrypted) request. The mechanism then replaces the HTTPS URLs with HTTP URLs that point to the same content/location, such that the same content would be accessed at the same location, but using an HTTP connection rather than an HTTPS connection. The mechanism then passes the content to a web browser, such as to a computing device executing the web browser. The proxy also tracks such substitutions and tracks accesses of the content from the web browser, so that when URIs are accessed, the proxy may determine whether a particular URL being accessed is one that was previously downgraded. If so, the proxy requests the HTTPS content on behalf of the user. Because the HTTPS connection is being requested by the proxy, rather than by the local client device 101 or computing device, the HTTPS connection terminates at the proxy and the proxy is able to inspect the content received over the HTTPS connection. The proxy then filters the response and returns the content to the web browser over HTTP, as discussed above.

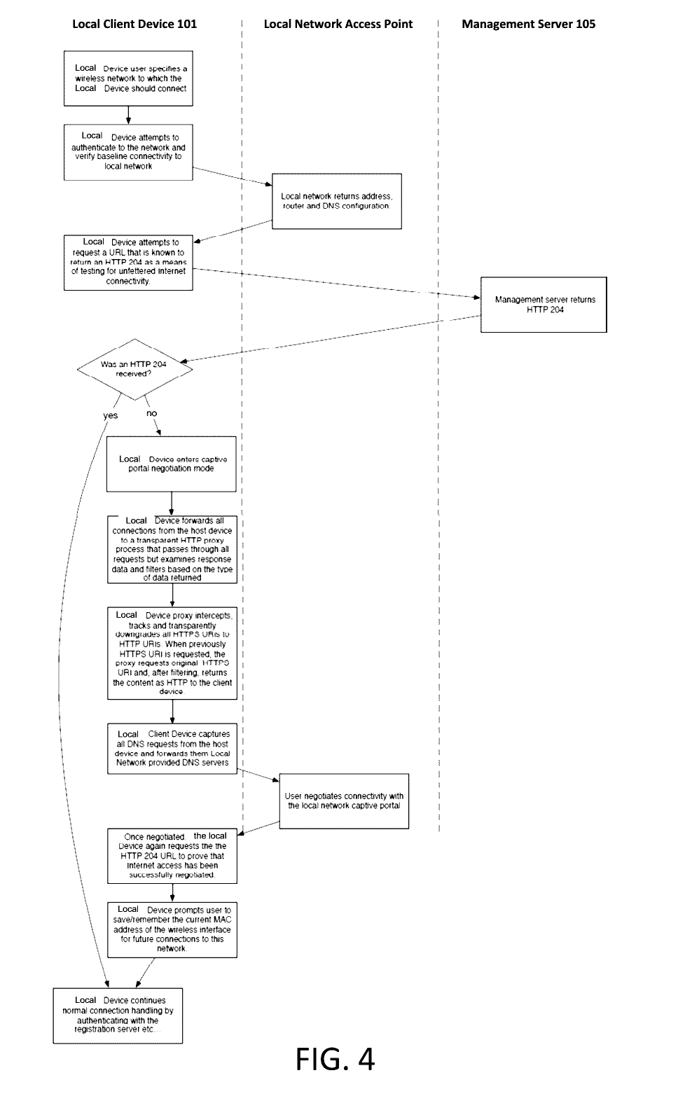

FIG. 4 illustrates a captive portal detection, Man-in-the-middle, and secure negotiation method according to some embodiments. First, the user of the local client device 101 selects a wireless network to which the device is to connect. The local client device 101 then attempts to authenticate to the network access point and verify baseline connectivity to the local network. The local network access point then returns the address of the local client device 101, router information, and DNS configuration information.

The local client device 101 then attempts to request a URL that is known to return an HTTP 204 response. For example, the management server 105 may include a URL that returns an HTTP 204 response with zero content. If the local client device 101 receives an HTTP 204 response it continues normal connection handling. However, if the local client device 101 instead receives a response that includes content, the local client device 101 enters captive portal negotiation mode.

Once in captive portal negotiation mode, the local client device 101 forwards connections from the host device to a transparent HTTP proxy process that passes through the requests but examines the response data and filters based on the type of data returned. The local client device proxy intercepts, tracks and transparently downgrades HTTPS URLs to HTTP URLs. The local client device 101 also captures DNS requests from the host device and forwards them to the DNS servers provided by the local network.

Being protected by the proxy, the local client device 101 then negotiates connectivity with the local network access point. Once negotiated, the local client device 101 again requests the HTTP 204 URL to verify that unfettered Internet access has been successfully negotiated. The local client device 101 then prompts the user to save the current MAC address of the wireless interface or does so automatically. Finally, the local client device 101 proceeds with establishing a connection via the management server 105 as described above.

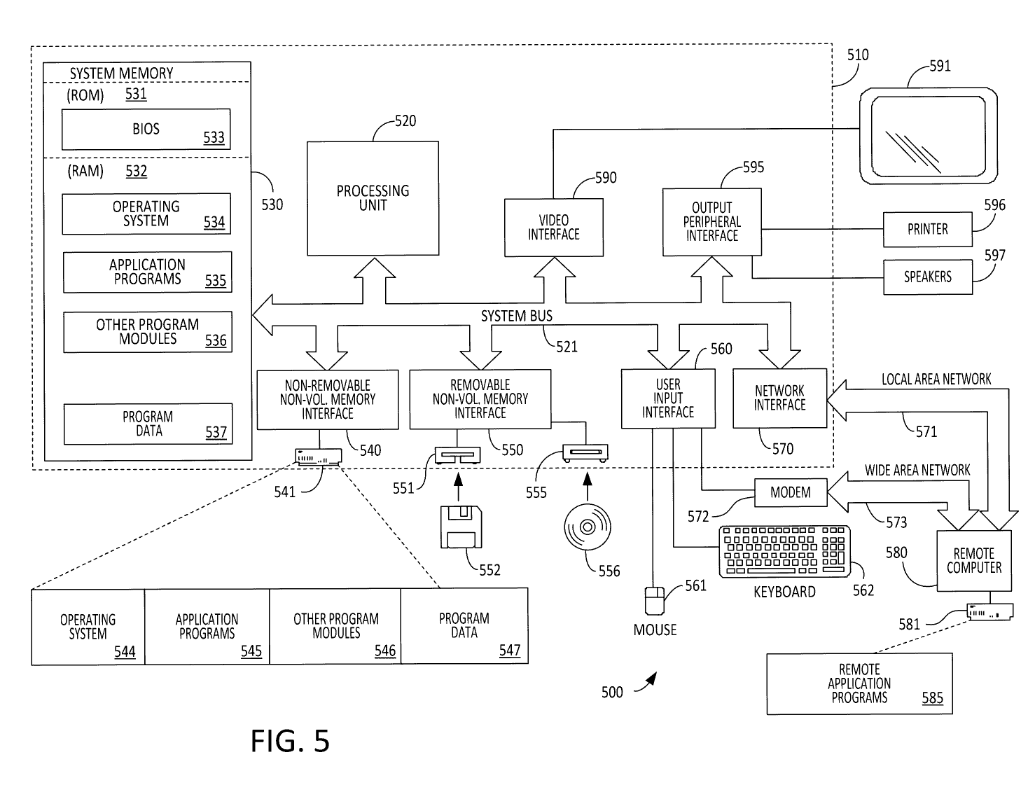

FIG. 5 illustrates an example of a suitable computing system environment 500 on which embodiments may be implemented. For example, the local client device 101, the management server 105 and/or the cloud provisioning server 103 may be implemented using a computing system environment 500. The computing system environment 500 is only one example of a suitable computing environment and is not intended to suggest any limitation as to the scope of use or functionality of the invention. Neither should the computing environment 500 be interpreted as having any dependency or requirement relating to any one or combination of components illustrated in the exemplary operating environment 500.

The invention is operational with numerous other general purpose or special purpose computing system environments or configurations. Examples of well-known computing systems, environments, and/or configurations that may be suitable for use with the invention include, but are not limited to, personal computers, server computers, hand-held or laptop devices, smartphones, tablets, multiprocessor systems, microprocessor-based systems, set top boxes, programmable consumer electronics, network PCs, minicomputers, mainframe computers, distributed computing environments that include any of the above systems or devices, and the like. Some of the elements illustrated in FIG. 5 may not be present, depending on the specific type of computing device. Alternatively, additional elements may be present in some implementations.

The computing environment may execute computer-executable instructions, such as program modules. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 5, an exemplary system for implementing the invention includes a general purpose computing device in the form of a computer 510. Components of computer 510 may include, but are not limited to, a processing unit 520, a system memory 530, and a system bus 521 that couples various system components including the system memory to the processing unit 520. The system bus 521 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 510 typically includes a variety of computer readable media. Computer readable media can be any available media that can be accessed by computer 510 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 510. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 530 includes computer storage media in the form of volatile and/or nonvolatile memory such as read only memory (ROM) 531 and random access memory (RAM) 532. A basic input/output system 533 (BIOS), containing the basic routines that help to transfer information between elements within computer 510, such as during start-up, is typically stored in ROM 531. RAM 532 typically contains data and/or program modules that are immediately accessible to and/or presently being operated on by processing unit 520. By way of example, and not limitation, FIG. 5 illustrates operating system 534, application programs 535, other program modules 536, and program data 537.

The computer 510 may also include other removable/non-removable, volatile/nonvolatile computer storage media. By way of example only, FIG. 5 illustrates a hard disk drive 541 that reads from or writes to non-removable, nonvolatile magnetic media, a magnetic disk drive 551 that reads from or writes to a removable, nonvolatile magnetic disk 552, and an optical disk drive 555 that reads from or writes to a removable, nonvolatile optical disk 556 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 541 is typically connected to the system bus 521 through an non-removable memory interface such as interface 540, and magnetic disk drive 551 and optical disk drive 555 are typically connected to the system bus 521 by a removable memory interface, such as interface 550.

The drives and their associated computer storage media discussed above and illustrated in FIG. 5, provide storage of computer readable instructions, data structures, program modules and other data for the computer 510. In FIG. 5, for example, hard disk drive 541 is illustrated as storing operating system 544, application programs 545, other program modules 546, and program data 547. Note that these components can either be the same as or different from operating system 534, application programs 535, other program modules 536, and program data 537. Operating system 544, application programs 545, other program modules 546, and program data 547 are given different numbers here to illustrate that, at a minimum, they are different copies. A user may enter commands and information into the computer 510 through input devices such as a keyboard 562 and pointing device 561, commonly referred to as a mouse, trackball or touch pad. Other input devices (not shown) may include a microphone, joystick, game pad, satellite dish, scanner, or the like. These and other input devices are often connected to the processing unit 520 through a user input interface 560 that is coupled to the system bus, but may be connected by other interface and bus structures, such as a parallel port, game port or a universal serial bus (USB). A monitor 591 or other type of display device is also connected to the system bus 521 via an interface, such as a video interface 590. In addition to the monitor, computers may also include other peripheral output devices such as speakers 597 and printer 596, which may be connected through a output peripheral interface 595.

The computer 510 may operate in a networked environment using logical connections to one or more remote computers, such as a remote computer 580. The remote computer 580 may be a personal computer, a server, a router, a network PC, a peer device or other common network node, and typically includes many or all of the elements described above relative to the computer 510, although only a memory storage device 581 has been illustrated in FIG. 5. The logical connections depicted in FIG. 5 include a local area network (LAN) 571 and a wide area network (WAN) 573, but may also include other networks. Such networking environments are commonplace in offices, enterprise-wide computer networks, intranets and the Internet.

When used in a LAN networking environment, the computer 510 is connected to the LAN 571 through a network interface or adapter 570. When used in a WAN networking environment, the computer 510 typically includes a modem 572 or other means for establishing communications over the WAN 573, such as the Internet. The modem 572, which may be internal or external, may be connected to the system bus 521 via the user input interface 560, or other appropriate mechanism. In a networked environment, program modules depicted relative to the computer 510, or portions thereof, may be stored in the remote memory storage device. By way of example, and not limitation, FIG. 5 illustrates remote application programs 585 as residing on memory device 581. It will be appreciated that the network connections shown are exemplary and other means of establishing a communications link between the computers may be used.

1. A first computing device for securing data communication across at least one network, the first computing device comprising:
at least one processor; and
at least one storage medium having encoded thereon executable instructions that, when executed by the at least one processor, cause the at least one processor to carry out a method comprising:
receiving, from a client device, at least one client request regarding a data pathway via the at least one network;
in accordance with the data pathway of the at least one client request, instantiating a plurality of resources in the at least one network to support the data pathway, wherein instantiating the plurality of resources comprises instantiating one or more bounce servers and an egress server in the at least one network, wherein the data pathway will traverse the one or more bounce servers and terminate at the egress server; and
in response to receiving first information regarding the one or more bounce servers and the egress server:
transmitting, to the client device, second information facilitating connection between the client device and a first bounce server of the one or more bounce servers.

2. The first computing device of claim 1, wherein instantiating the plurality of resources comprises:
transmitting, to at least one second server, a request for the instantiation of the one or more bounce servers and the egress server; and
receiving, from the at least one second server, the first information regarding the one or more bounce servers and the egress server.

3. The first computing device of claim 1, wherein:
the at least one second server is one or more provisioning servers managing instantiation of virtual machines in one or more distributed computing environments; and
transmitting the request for the instantiation comprises transmitting one or more requests to one or more of the at least one second server that the one or more bounce servers and the egress server be instantiated as virtual machines in the one or more distributed computing environments.

4. The first computing device of claim 3, wherein:
the one or more distributed computing environments are a plurality of distributed computing environments and the at least one second server is a plurality of second servers;
the at least one client request identifies one or more selected distributed computing environments, of the plurality of distributed computing environments, to be included in the data pathway; and
transmitting the one or more requests to the one or more of the at least one second server comprises transmitting the one or more requests to one or more second servers, of the plurality of second servers, that are associated with the one or more selected distributed computing environments.

5. The first computing device of claim 1, wherein:
the method further comprises:
receiving at least one additional client request to alter the data pathway;
in accordance with the altered data pathway of the at least one additional client request, instantiating at least one new bounce server and/or a new egress server; and
transmitting, to the client device, third information facilitating connection between the client device and a second bounce server of the at least one new bounce server.

6. The first computing device of claim 1, wherein:
the method further comprises:
refraining from transmitting, to the client device, information regarding the egress server;
instantiating a second bounce server;
transmitting, to the first bounce server and/or the second bouncer server, information facilitating connection between the first bounce server and the second bounce server; and
refraining from transmitting, to the first bounce server and the egress server, information facilitating connection between the first bounce server and the egress server.

7. The first computing device of claim 1, wherein:
the method further comprises:
instantiating at least one certificate authority;
using the at least one certificate authority, signing at least one server certificate from the one or more bounce servers and/or the egress server; and
using the at least one certificate authority, signing at least one client certificate from the client device.

8. The first computing device of claim 1, wherein:
the method further comprises:
transmitting a plurality of pairs of ports and protocols to the client device;
listening for traffic on the plurality of pairs of ports and protocols;
receiving at least one message from the client device via one pair of the plurality of pairs of ports and protocols; and
transmitting at least one response to the client device, the at least one response including at least one attribute relating to how the at least one message was received.

9. The first computing device of claim 8, wherein:
the at least one attribute comprises a port and/or a protocol via which the at least one message was received from the client device by the first computing device.

10. At least one computer-readable storage medium encoded with executable instructions that, when executed by at least one processor of a first computing device, cause the at least one processor to carry out a method for securing data communication across at least one network, the method comprising:
receiving, from a client device, at least one client request regarding a data pathway via the at least one network;
in accordance with the data pathway of the at least one client request, instantiating a plurality of resources in the at least one network to support the data pathway, wherein instantiating the plurality of resources comprises instantiating one or more bounce servers and an egress server in the at least one network, wherein the data pathway will traverse the one or more bounce servers and terminate at the egress server;
in response to receiving, from the at least one second server, first information regarding the one or more bounce servers and the egress server:
transmitting, to the client device, second information facilitating connection between the client device and a first bounce server of the one or more bounce servers; and
refraining from transmitting, to the client device, information regarding the egress server;
instantiating a new egress server;
instantiating a second bounce server;
transmitting, to the first bounce server and/or the second bouncer server, information facilitating connection between the first bounce server and the second bounce server; and
refraining from transmitting, to the first bounce server and the egress server, information facilitating connection between the first bounce server and the egress server.

11. At least one computer-readable storage medium encoded with executable instructions that, when executed by at least one processor of a client device, cause the at least one processor to carry out a method for securing data communication across at least one network, the method comprising:
receiving, from a user via a user interface, selection of one or more options for a data pathway, wherein the one or more options comprise an indication of a number of bounce servers to include in the data pathway and one or more distributed computing environments in which the number of bounce servers is to be instantiated;
transmitting, to a first server, at least one client request for the data pathway indicating the one or more options;
receiving, from the first server, information facilitating connection between the client device and a first bounce server of the number of bounce servers; and
forming a connection to the first bounce server without receiving information regarding an egress server.

12. The at least one computer-readable storage medium of claim 11, wherein:
the method further comprises:
transmitting a connection request to the first bounce server for connection with the egress server;
in response to receiving, from the egress server via the first bounce server, a response to the connection request, forming a virtual private network connection with the egress server.

13. The at least one computer-readable storage medium of claim 11, wherein:
the one or more options comprise a location of at least one of the number of bounce servers and/or a location of the egress server.

14. The at least one computer-readable storage medium of claim 11, wherein:
the method further comprises:
receiving at least one additional client request to alter the data pathway;
in accordance with the altered data pathway of the at least one additional client request, transmitting a first request to the first server for instantiation of at least one new bounce server and/or a new egress server; and
receiving a response to the first request from the first server facilitating connection between the client device and a second bounce server of the at least one new bounce server.

15. The at least one computer-readable storage medium of claim 11, wherein:
the method further comprises:
receiving, from the first server, information regarding selectable options for the data pathway; and
outputting, for presentation to the user, the selectable options for the data pathway for selection by the user.

16. The at least one computer-readable storage medium of claim 11, wherein:
the method further comprises:
receiving, from the first server, a plurality of pairs of ports and protocols;
iteratively transmitting at least one message to the first server via at least one pair of the plurality of pairs of ports and protocols;
receiving at least one response from the first server, the at least one response including at least one attribute relating to how the at least one message was received; and
forming the connection to the first bounce server based on the at least one attribute.

17. The at least one computer-readable storage medium of claim 16, wherein:
the at least one attribute comprises a port and/or a protocol via which the at least one message was received from the client device by the first server.

18. The at least one computer-readable storage medium of claim 11, wherein:
the method further comprises:
requesting an asset for which first content is expected;
in response to receiving second content for the requested asset different from the first content:
modifying the second content using at least one proxy before relaying the second content to a browser accessible by the user.

19. The at least one computer-readable storage medium of claim 18, wherein:
modifying the second content using the at least one proxy comprises:
detecting, using the at least one proxy, uncommon content in the second content; and
removing the uncommon content from the second content.

20. The at least one computer-readable storage medium of claim 19, wherein:
the uncommon content comprises executable content and/or binary content.

21. The at least one computer-readable storage medium of claim 18, wherein:
modifying the second content using the at least one proxy comprises:
in response to detecting that accessing the second content will create an encrypted connection, requesting the asset via an unencrypted connection; and
using the at least one proxy, in response to detecting that the asset has been requested via the unencrypted connection, requesting the asset via an encrypted connection for modification of the second content by the at least one proxy.

22. The at least one computer-readable storage medium of claim 11, wherein:
the method further comprises:
interfacing with a host device for which the client device serves as an intermediary between the client device and a network including the first server.
